(19) United States
(12) Patent Application Publication
(10) Pub. No.: US 2023/0054581 A1
(43) Pub. Date: Feb. 23, 2023

(54) VEHICLE INPUT CONTROL DEVICE, VEHICLE INPUT CONTROL SYSTEM, VEHICLE INPUT CONTROL METHOD, AND NON-TRANSITORY STORAGE MEDIUM IN WHICH PROGRAM IS STORED

(71) Applicant: TOYOTA JIDOSHA KABUSHIKI KAISHA, Toyota-shi (JP)

(72) Inventors: Yuki KOZONO, Okazaki-shi (JP); Shu NAKAJIMA, Toyota-shi (JP)

(73) Assignee: TOYOTA JIDOSHA KABUSHIKI KAISHA, Toyota-shi (JP)

(21) Appl. No.: 17/859,177

(22) Filed: Jul. 7, 2022

(30) Foreign Application Priority Data
Aug. 19, 2021 (JP) 2021-134254

(51) Int. Cl. B60K 35/00; B60W 50/14

(52) U.S. Cl. CPC B60K 35/00; B60W 50/14; B60K 2370/1446; B60K 2370/197; B60K 2370/199; B60K 2370/782; B60K 2370/785; B60W 2050/146

(57) ABSTRACT

A vehicle input control device includes: an operation reception unit that receives input from operation switches provided in a vicinity of a driver's seat of a vehicle; a function switching reception unit that receives input from function switching switches that switch functions allocated to the operation switches; and a function switching restriction unit that restricts switching of the functions by the function switching reception unit in a case in which a driving mode of the vehicle is a predetermined driving mode.

### CROSS-REFERENCE TO RELATED APPLICATION

This application is based on and claims priority under 35 USC 119 from Japanese Patent Application No. 2021-134254 filed on Aug. 19, 2021, the disclosure of which is incorporated by reference herein.

### BACKGROUND

### Technical Field

The present disclosure relates to a vehicle input control device, a vehicle input control system, a vehicle input control method, and a non-transitory storage medium in which a program is stored.

### Related Art

Japanese Patent Application Laid-open (JP-A) No. 2021-75157 discloses a vehicle input device where plural operation switches are provided in a steering wheel. Specifically, in JP-A No. 2021-75157, the vehicle input device is configured in such a way that when an image displayed on a display screen is switched, different functions are allocated to each of the operation switches. Furthermore, the vehicle input device detects a preliminary action just before an operation switch is operated and notifies an occupant.

In a vehicle input control device that can allocate different functions to operation switches such as disclosed in JP-A No. 2021-75157, there is room for improvement from the standpoint of inhibiting mistaken operations while the vehicle is driving in a predetermined driving mode.

### SUMMARY

The present disclosure provides a vehicle input control device that inhibits mistaken operations while the vehicle is driving in a predetermined driving mode in a vehicle input control device that may allocate different functions to operation switches, a vehicle input control system, a vehicle input control method, and a non-transitory storage medium in which a program is stored.

A first aspect of the present disclosure is a vehicle input control device including: an operation reception unit that receives input from operation switches provided in a vicinity of a driver's seat of a vehicle; a function switching reception unit that receives input from function switching switches that switch functions allocated to the operation switches; and a function switching restriction unit that restricts switching of the functions by the function switching reception unit in a case in which a driving mode of the vehicle is a predetermined driving mode.

In the vehicle input control device of the first aspect, the operation reception unit receives input from the operation switches provided in the vicinity of the driver's seat. Here, the functions allocated to the operation switches are configured to be switched by operating the function switching switches, and the function switching reception unit receives input from the function switching switches. Due thereto, plural functions may be allocated to the operation switches, and the number of operation switches may be reduced.

Furthermore, the function switching restriction unit restricts switching of the functions by the function switching reception unit in a case in which the driving mode of the vehicle is the predetermined driving mode. Due thereto, even if the occupant mistakenly operates the function switching switches in the predetermined driving mode, the functions allocated to the operation switches may be inhibited from being switched. It will be noted that the “operation switches” and the “function switching switches” here are not limited to mechanical switches where input is performed as a result of being pressed. For example, they may also be switches equipped with a mechanism where input is performed by detecting a predetermined load or greater and a mechanism where input is performed by detecting operation thereof with a sensor such as an electrostatic sensor.

A second aspect of the present disclosure, in the first aspect, may further include: a function display unit that causes display of the functions allocated to the operation switches at a display region in a cabin of the vehicle, wherein the function display unit changes the display in a case in which the function switching reception unit has received input from the function switching switches, and maintains, without changing, the display in a case in which switching is restricted by the function switching restriction unit.

In the vehicle input control device of the second aspect, the function display unit displays the functions allocated to the operation switches in the display region in the cabin, so the occupant may easily grasp the functions allocated to the operation switches. Furthermore, the function display unit does not switch the display when switching is restricted by the function switching restriction unit. Due thereto, by viewing the display region, the occupant may grasp that switching of the functions is restricted.

A third aspect of the present disclosure, in the first aspect or the second aspect, may further include: a notification unit that notifies an occupant in a case in which switching of the functions by the function switching reception unit is restricted by the function switching restriction unit.

In the vehicle input control device of the third aspect, the notification unit notifies the occupant, so the occupant may easily grasp that switching of the functions is restricted.

In a fourth aspect of the present disclosure, in any one of the first aspect to the third aspect, in a case in a case in which the driving mode is a driving assistance mode that performs driving assistance, functions relating to driving assistance settings are allocated to at least some of the operation switches, and the function switching restriction unit may restrict switching of the functions by the function switching reception unit in a case in which the driving mode is the driving assistance mode.

In the vehicle input control device of the fourth aspect, in a case in which the driving mode is the driving assistance mode, the functions allocated to the operation switches may be inhibited from being switched from the functions relating to the driver assistance settings.

A fifth aspect of the present disclosure, in the fourth aspect, the driving assistance mode may include a cruise control mode, and functions for changing vehicle speed and changing headway during cruise control are allocated to at least some of the operation switches.

In the vehicle input control device of the fifth aspect, in the driving assistance mode, functions relating to changing vehicle speed and functions relating to changing headway during cruise control may be fixed.

A sixth aspect of the present disclosure is a vehicle input control system including: the vehicle input control device of any one of claims 1 to 5; and the operation switches and the function switching switches provided in the vicinity of the driver's seat.

A seventh aspect of the present disclosure is a vehicle input control method including: receiving input from operation switches provided in a vicinity of a driver's seat of a vehicle; receiving input from function switching switches that switch functions of the operation switches; and restricting switching of the functions by the function switching restriction unit in a case in which a driving mode of the vehicle is a predetermined driving mode.

An eighth aspect of the present disclosure is a non-transitory storage medium storing a program executable by a computer to perform a process, the process including: receiving input from operation switches provided in a vicinity of a driver's seat of a vehicle; receiving input from function switching switches that switch functions of the operation switches; and restricting switching of the functions by the function switching restriction unit in a case in which a driving mode of the vehicle is a predetermined driving mode.

As described above, according to the vehicle input control device, the vehicle input control system, the vehicle input control method, and the non-transitory storage medium in which is stored a program pertaining to the present disclosure, mistaken operations may be inhibited while the vehicle is driving in a predetermined driving mode in a vehicle input control device that may allocate different functions to operation switches.

### BRIEF DESCRIPTION OF THE DRAWINGS

An exemplary embodiment of the present disclosure will be described in detail based on the following figures, wherein:

FIG. 1 is a schematic view illustrating, from a vehicle rear side, the front portion of a cabin in a vehicle to which a vehicle input control system pertaining to the exemplary embodiment has been applied;

FIG. 2 is a block diagram illustrating hardware configurations of the vehicle input control system pertaining to the exemplary embodiment;

FIG. 3 is a block diagram illustrating functional configurations of a vehicle input control device pertaining to the exemplary embodiment;

FIG. 4 is a drawing illustrating an example of what is displayed in a display region in the exemplary embodiment, and illustrates an example of what is displayed when right-side operation switches and left-side operation switches have not been touched;

FIG. 5 is a drawing illustrating an example of what is displayed when a right-side operation switch has been touched from the state illustrated in FIG. 4;

FIG. 6 is a drawing illustrating an example of what is displayed when a right-side function switching switch has been operated from the state illustrated in FIG. 5;

FIG. 7 is a drawing illustrating an example of what is displayed when the right-side function switching switch has been operated in a driving assistance mode; and

FIG. 8 is a flowchart illustrating an example of the flow of an input control process in the exemplary embodiment.

### DETAILED DESCRIPTION

A vehicle input control system S pertaining to the exemplary embodiment will now be described with reference to the drawings.

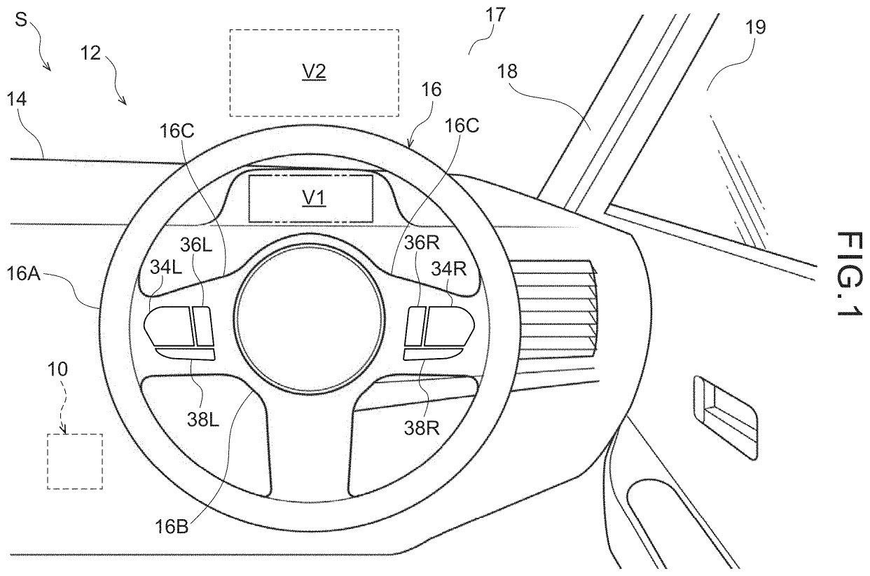

As illustrated in FIG. 1, in the front portion of a cabin in a vehicle 12, an instrument panel 14 is provided. The instrument panel 14 extends in the vehicle width direction, and on the vehicle right side of the instrument panel 14, a steering wheel 16 is provided. That is, in this exemplary embodiment, as an example, the vehicle 12 is a right-hand-drive car where the steering wheel 16 is provided on the right side, and the driver's seat is set on the vehicle right side. Furthermore, the steering wheel 16 is provided with a right first operation switch 34R, a right second operation switch 36R, a right function switching switch 38R, a left first operation switch 34L, a left second operation switch 36L, and a left function switching switch 38L. These switches will be described later.

On the front end portion of the instrument panel 14, a windshield glass 17 is provided. The windshield glass 17 extends in the vehicle up and down direction and the vehicle width direction and partitions the cabin interior from the cabin exterior.

The vehicle right-side end portion of the windshield glass 17 is secured to a front pillar 18 on the vehicle right side. The front pillar 18 extends in the vehicle up and down direction, and the windshield glass 17 is secured to the vehicle width direction inner end portion of the front pillar 18. Furthermore, the front end portion of a front side glass 19 is secured to the vehicle width direction outer end portion of the front pillar 18. It will be noted that the vehicle left-side end portion of the windshield glass 17 is secured to a front pillar on the vehicle left side not illustrated in the drawings.

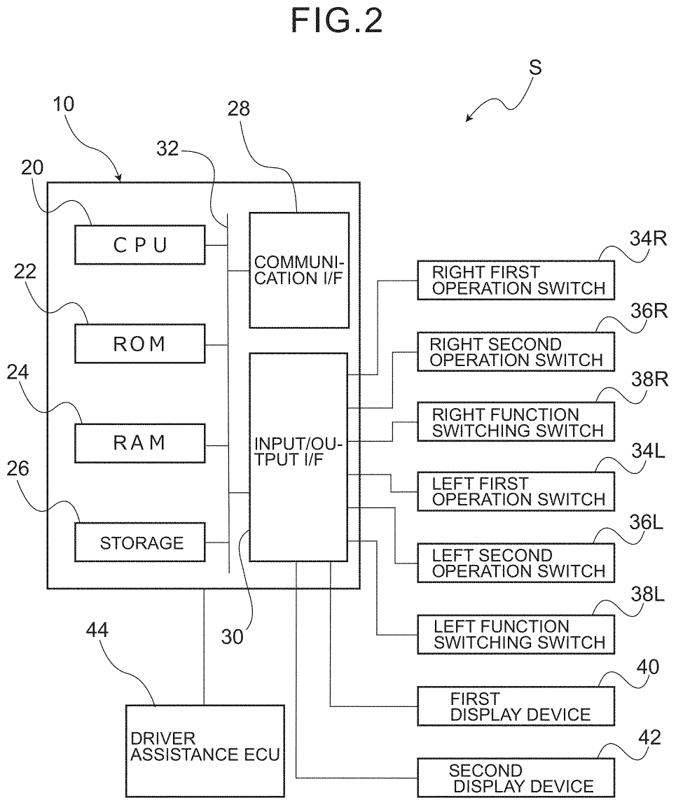

Here, the instrument panel 14 is provided with a display region V1 for images. The display region V1 is a meter display positioned on the vehicle right side of the instrument panel 14, and predetermined information is displayed in the display region V1 by a first display device 40 (see FIG. 2). The first display device 40 is connected to various types of meter instruments installed in the vehicle 12. The display region V1 is provided in a position in which it lies in the field of view of a driver when the driver is looking in the vehicle forward direction.

The windshield glass 17 is provided with a display region V2 for images. The display region V2 is set on the vehicle upper side of the display region V1 and is configured by a projection surface projected by a second display device 42 (see FIG. 2). Here, the second display device 42 is a head-up display device provided on the vehicle front side of the instrument panel 14, and is configured so that images are projected from the second display device 42 which is a head-up display device to the display region V2 of the windshield glass 17. That is, the display region V2 is a part of the windshield glass 17 that is configured to be a projection surface of the head-up display device.

Here, the steering wheel 16 is equipped with a substantially annular rim portion 16A, and on the inner peripheral side of the rim portion 16A is provided a hub portion 16B that configures a central portion of the steering wheel 16. Furthermore, the right side of the rim portion 16A and the hub portion 16B are interconnected by a spoke portion 16C, and the left side of the rim portion 16A and the hub portion 16B are interconnected by a spoke portion 16C. The spoke portion 16C on the right side is provided with the right first operation switch 34R, the right second operation switch 36R, and the right function switching switch 38R. Furthermore, the spoke portion 16C on the left side is provided with the left first operation switch 34L, the left second operation switch 36L, and the left function switching switch 38L.

The right first operation switch 34R is formed in a substantially rectangular shape and is disposed in the right upper portion of the spoke portion 16C on the right side. Furthermore, the right first operation switch 34R is configured to be capable of input in four directions, up, down, left, and right, and functions are allocated to each of those directions.

Here, in this exemplary embodiment, as an example, an electrostatic sensor not illustrated in the drawings is installed in the right first operation switch 34R, and functions that have been touched just by the occupant touching the right first operation switch 34R are selected. Furthermore, when the occupant presses the right first operation switch 34R in a state in which a function has been selected, the selected function is executed. Similar electrostatic sensors are also installed in the right second operation switch 36R, the right function switching switch 38R, the left first operation switch 34L, the left second operation switch 36L, and the left function switching switch 38L.

The right second operation switch 36R is formed in a substantially long rectangular shape whose lengthwise direction coincides with the up and down direction, and is disposed on the left side of the right first operation switch 34R. Furthermore, the right second operation switch 36R is configured to be capable of input in two directions, up and down, and functions are allocated to each of those directions.

The right function switching switch 38R is formed in a substantially long rectangular shape whose lengthwise direction coincides with the right and left direction, and is disposed under the right first operation switch 34R and the right second operation switch 36R. Furthermore, the right function switching switch 38R is a switch for switching functions. Specifically, by operating the right function switching switch 38R, the functions allocated to the right first operation switch 34R and the right second operation switch 36R are switched. In this exemplary embodiment, as an example, two functions are allocated to each of the operation switches, and the right function switching switch 38R is configured so that every time it is operated, the functions switch.

The left first operation switch 34L is formed in a substantially rectangular shape that is bilaterally symmetrical to the right first operation switch 34R, and is disposed in the left upper portion of the spoke portion 16C on the left side. Furthermore, the left first operation switch 34L is configured to be capable of input in four directions, up, down, left, and right, and functions are allocated to each of those directions.

The left second operation switch 36L is formed in a substantially long rectangular shape that is bilaterally symmetrical to the right second operation switch 36R, and is disposed on the right side of the left first operation switch 34L. Furthermore, the left second operation switch 36L is configured to be capable of input in two directions, up and down, and functions are allocated to each of those directions.

The left function switching switch 38L is formed in a substantially long rectangular shape that is bilaterally symmetrical to the right function switching switch 38R, and is disposed under the left first operation switch 34L and the left second operation switch 36L. Furthermore, the left function switching switch 38L is a switch for switching functions. Specifically, by operating the left function switching switch 38L, the functions allocated to the left first operation switch 34L and the left second operation switch 36L are switched.

Here, the vehicle 12 is provided with a vehicle input control device 10. The vehicle input control device 10 of this exemplary embodiment is, for example, a display electronic control unit (ECU) that performs various types of control. The vehicle input control system S is configured to include the right first operation switch 34R, the right second operation switch 36R, the right function switching switch 38R, the left first operation switch 34L, the left second operation switch 36L, the left function switching switch 38L, and the vehicle input control device 10.

(Hardware Configurations of Vehicle Input Control System S)

As illustrated in FIG. 2, the vehicle input control system S is configured to include the vehicle input control device 10.

The vehicle input control device 10 is configured to include a central processing unit (CPU: processor) 20, a read-only memory (ROM) 22, a random-access memory (RAM) 24, a storage 26, a communication interface (communication I/F) 28, and an input/output interface (input/output I/F) 30. These configurations are communicably connected to each other via an internal bus 32.

The CPU 20 is a central arithmetic processing unit, executes various types of programs, and controls each part of the vehicle input control device 10. That is, the CPU 20 reads programs from the ROM 22 or the storage 26 and executes the programs using the RAM 24 as a workspace. Furthermore, the CPU 20 controls each of the above configurations and performs various types of arithmetic processing in accordance with the programs stored in the ROM 22 or the storage 26.

The ROM 22 stores various types of programs and various types of data. The RAM 24 temporarily stores programs or data as a workspace. The storage 26 is configured by a hard disk drive (HDD) or a solid-state drive (SSD) and is a non-transitory storage medium that stores various types of programs, including an operating system, and various types of data. In this exemplary embodiment, the ROM 22 or the storage 26 stores a program for performing an input control process.

The communication I/F 38 is an interface for the vehicle input control device 10 to communicate with an external server and other devices, and uses a standard such as Controller Area Network (CAN), Ethernet (registered trademark), Long-Term Evolution (LTE), Fiber Distributed Data Interface (FDDI), or Wi-Fi (registered trademark), for example.

Electrically connected to the input/output interface 30 are the right first operation switch 34R, the right second operation switch 36R, the right function switching switch 38R, the left first operation switch 34L, the left second operation switch 36L, the left function switching switch 38L, the first display device 40, and the second display device 42.

The first display device 40 is a device that performs predetermined displays in the display region V1 of the meter display. Furthermore, the second display device 42 is a device that performs predetermined displays in the display region V2 of the head-up display.

Furthermore, the vehicle input control device 10 is electrically connected to a driver assistance ECU 44. The driver assistance ECU 44 of this exemplary embodiment, as an example, performs control such as active cruise control (ACC) and lane tracing assist (LTA). For this reason, the driver assistance ECU 44 is configured to be able to acquire signals from sensors that detect the surroundings of the vehicle 12.

(Functional Configurations of Vehicle Input Control Device 10)

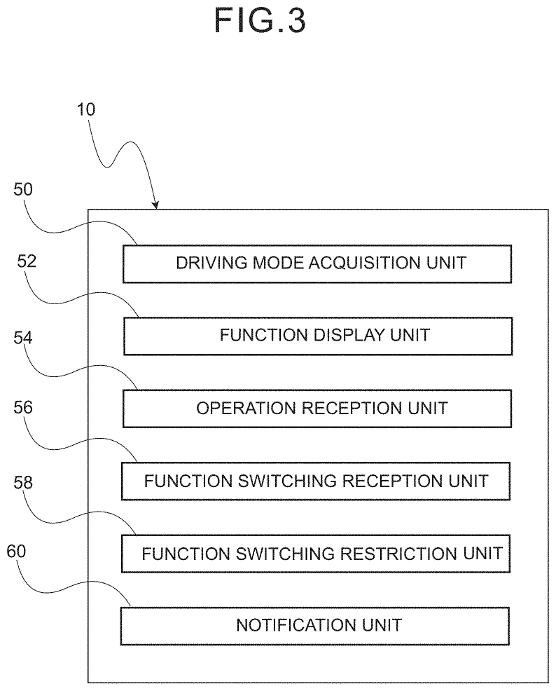

The vehicle input control device 10 uses the above hardware resources to realize various types of functions. The functional configurations realized by the vehicle input control device 10 will now be described with reference to FIG. 3.

As illustrated in FIG. 3, the vehicle input control device 10 is configured to include, as functional configurations, a driving mode acquisition unit 50, a function display unit 52, an operation reception unit 54, a function switching reception unit 56, a function switching restriction unit 58, and a notification unit 60. It will be noted that these functional configurations are realized as a result of the CPU 20 reading and executing programs stored in the ROM 22 or the storage 26.

The driving mode acquisition unit 50 acquires the current driving mode of the vehicle 12. The driving mode acquisition unit 50 of this exemplary embodiment, as an example, acquires, in regard to a cruise control mode in which ACC is switched on and a lane tracing assist mode in which LTA is switched on, the fact that the current driving mode is these driving modes.

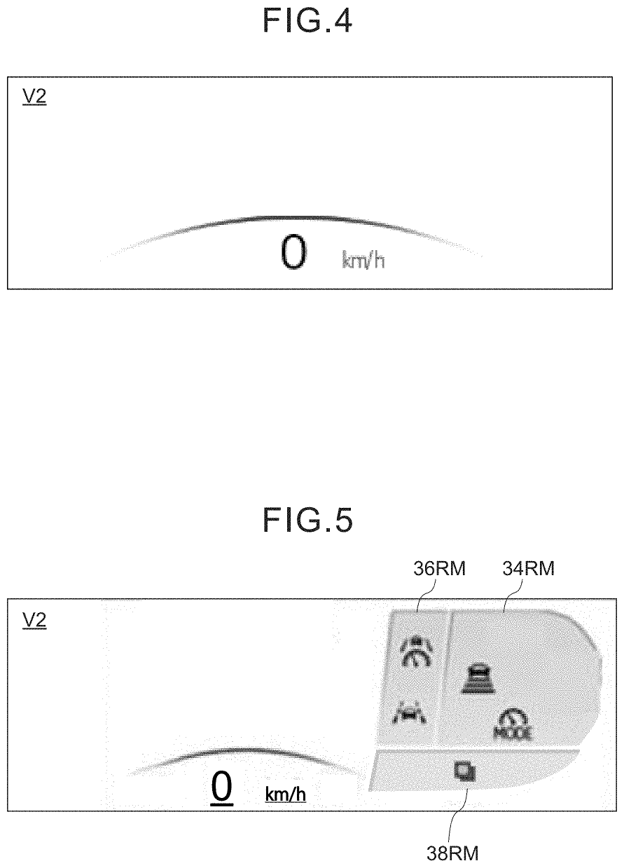

The function display unit 52 displays the functions allocated to the operation switches in at least one of the display region V1 and the display region V2 in the cabin. The function display unit 52 of this exemplary embodiment, as an example, displays in the display region V2 the functions allocated to the operation switches on the side touched by the occupant out of the left and right operation switches. For example, FIG. 4 illustrates an example of what is displayed in the display region V2 in a case in which the occupant has not touched any of the operation switches. In this state, the vehicle speed of the vehicle 12 is illustrated in the lower central portion of the display region V2.

Furthermore, the function display unit 52 switches the display when the function switching reception unit 56 has received input from the function switching switches, and maintains, without switching, the display when switching is restricted by the function switching restriction unit 58. Details will be described later.

Next, in a case in which the occupant has touched any of the right first operation switch 34R, the right second operation switch 36R, and the right function switching switch 38R, the display moves from the state illustrated in FIG. 4 to the state illustrated in FIG. 5. As illustrated in FIG. 5, in the right-side end portion of the display region V2 are displayed a right first operation switch image 34RM with a shape in imitation of the right first operation switch 34R, a right second operation switch image 36RM with a shape in imitation of the right second operation switch 36R, and a right function switching switch image 38RM with a shape in imitation of the right function switching switch 38R.

Here, as an example, icons are not displayed in the upper portion and the right portion of the right first operation switch image 34RM. In this way, in a case in which there are no allocated functions, icons are not displayed.

In the left portion of the right first operation switch image 34RM is displayed an icon relating to setting the headway, and when this icon is selected, the headway may be set. That is, a function for setting the headway is allocated to the left portion of the right first operation switch 34R.

In the lower portion of the right first operation switch image 34RM is displayed an icon relating to switching the driving mode, and when this icon is selected, the driving mode is switched. That is, a function for switching the driving mode is allocated to the lower portion of the right first operation switch 34R.

In the upper portion of the right second operation switch image 36RM is displayed an icon relating to switching a ACC on and off, and when this icon is selected, the ACC switches on or off. Furthermore, in the lower portion of the right second operation switch image 36RM is displayed an icon relating to switching LTA on and off, and when this icon is selected, LTA switches on or off.

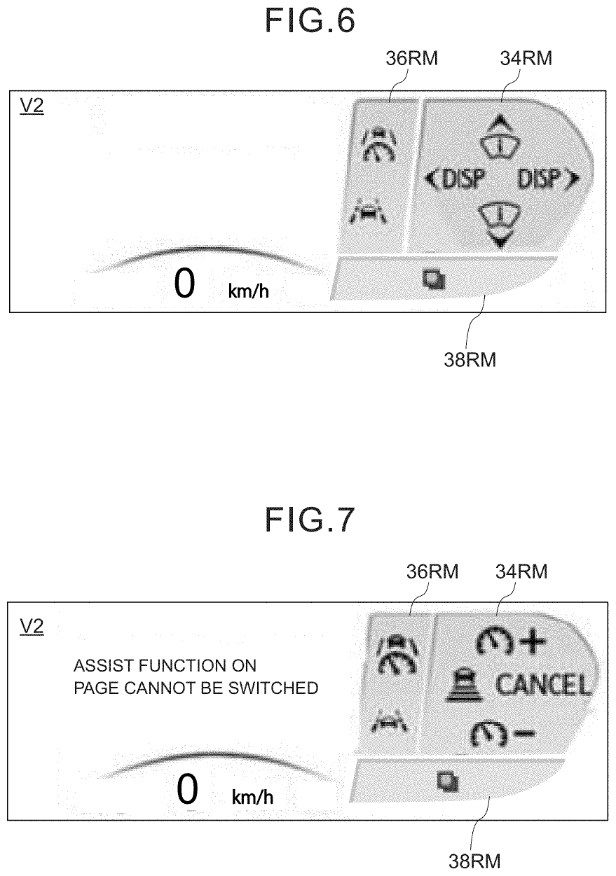

In the right function switching switch image 38RM is displayed an icon for switching functions, and when this icon is selected, the functions allocated to the right first operation switch 34R and the right second operation switch 36R switch. In this exemplary embodiment, as an example, when the right function switching switch 38R is operated in the state illustrated in FIG. 5, the display is switched by the function display unit 52 and moves to the state illustrated in FIG. 6. As illustrated in FIG. 6, the icons in the right first operation switch image 34RM are changed, and the occupant may visually see that the allocated functions have been switched. It will be noted that the function display unit 52 of this exemplary embodiment, as an example, holds the display content before each image disappears, and when it displays the images again, the held display content is displayed in the display region V2. However, when power to the vehicle 12 is switched off, the held display content is reset, and the next time power is switched on, predetermined display content is displayed.

The operation reception unit 54 illustrated in FIG. 3 receives input from the operation switches. Specifically, when any of the right first operation switch 34R, the right second operation switch 36R, the left first operation switch 34L, and the left second operation switch 36L has been pressed, the operation reception unit 54 executes the functions of the switch that has been pressed. At this time, in this exemplary embodiment, as an example, the operation reception unit 54 does not receive other input operations until an operation guide display illustrating the functions is performed in the display region V2 after the operation reception unit 54 has received input from the operation switches. It will be noted that in a case in which the operation guide display is displayed as an animation, the operation reception unit 54 does not receive other input operations until the animation ends.

The function switching reception unit 56 receives input from the function switching switches. Specifically, when either of the right function switching switch 38R and the left function switching switch 38L has been pressed, the function switching reception unit 56 switches the functions of the operation switches on the side that has been pressed.

The function switching restriction unit 58 restricts switching of the functions by the function switching reception unit 56 in a case in which the driving mode of the vehicle 12 is a predetermined driving mode. In this exemplary embodiment, as an example, the function switching restriction unit 58 restricts switching of the functions by the function switching reception unit 56 in a case in which the driving mode is a driving assistance mode.

The notification unit 60 notifies the occupant when switching of the functions by the function switching reception unit 56 is restricted by the function switching restriction unit 58.

Here, the functions of the function switching restriction unit 58 and the notification unit 60 will be described using FIG. 7. FIG. 7 illustrates the right first operation switch image 34RM, the right second operation switch image 36RM, and the right function switching switch image 38RM in a state in which the driving mode is an ACC mode which is an example of the driving assistance mode.

Specifically, in the upper portion of the right first operation switch image 34RM is displayed an icon for increasing the vehicle speed, and in the lower portion of the right first operation switch image 34RM is displayed an icon for decreasing the vehicle speed. Furthermore, in the right portion of the right first operation switch image 34RM is displayed an icon for switching off ACC. Moreover, in the left portion of the right first operation switch image 34RM is displayed an icon for changing the headway. In this way, in a case in which the driving mode is the driving assistance mode that performs driver assistance, functions relating to driver assistance settings are allocated to at least some of the operation switches.

Here, if the occupant selects and presses the right function switching switch 38R, switching of the functions is restricted by the function switching restriction unit 58. That is, the functions are not switched and neither is the display changed. Furthermore, characters indicating that the functions may not be switched are displayed in the display region V2 by the notification unit 60.

(Operation)

Next, the operation of this exemplary embodiment will be described.

(Input Control Process)

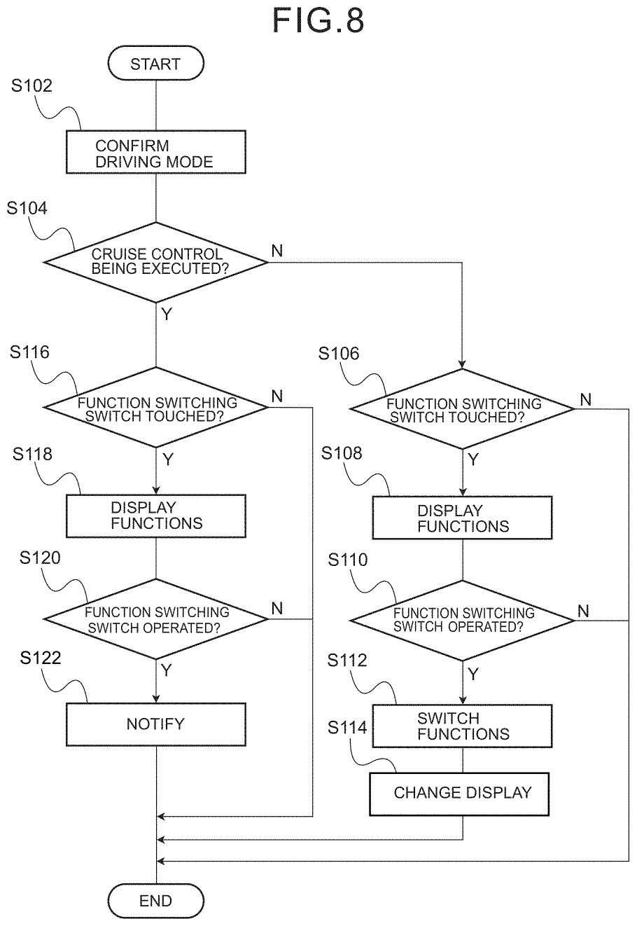

An example of the input control process performed by the vehicle input control device 10 will now be described using the flowchart illustrated in FIG. 8. The input control process is executed as a result of the CPU 20 reading an input control program from the ROM 22 or the storage 26, transferring it to the RAM 24, and executing it.

In step S102 the CPU 20 confirms the driving mode. Specifically, the CPU 20 confirms the driving mode by using the function of the driving mode acquisition unit 50 to acquire the current driving mode of the vehicle 12.

In step S104 the CPU 20 determines whether or not cruise control is being executed. Specifically, the CPU 20 determines, from information about the driving mode acquired by the driving mode acquisition unit 50, that cruise control is being executed in a case in which the ACC function is on, and then the CPU 20 moves to the process of step S116. In a case in which the ACC function is off, the CPU 20 determines that cruise control is not being executed and moves to the process of step S106. In the following description, processes from step S106 on will be described first and processes from step S116 on will be described later.

In step S106 the CPU 20 determines whether or not the occupant has touched a function switching switch. Specifically, in a case in which the occupant has touched the right function switching switch 38R or the left function switching switch 38L, the determination becomes YES in step S106 and the CPU 20 moves to the process of step S108. Furthermore, in a case in which the occupant has not touched either of the right function switching switch 38R and the left function switching switch 38L in step S106, the determination becomes NO in step S106 and the CPU 20 ends the input control process.

In step S108 the CPU 20 performs a predetermined display in the display region V2. For example, in a case in which the occupant has touched any of the right first operation switch 34R, the right second operation switch 36R, and the right function switching switch 38R, the CPU 20 uses the function display unit 52 to display the right first operation switch image 34RM, the right second operation switch image 36RM, and the right function switching switch image 38RM in the display region V2 (see FIG. 5).

Next, in step S110 the CPU 20 determines whether or not the function switching switch has been operated. Specifically, in a case in which the occupant has pressed the right function switching switch 38R in a state in which the right first operation switch image 34RM, the right second operation switch image 36RM, and the right function switching switch image 38RM are being displayed in the display region V2, the CPU 20 determines that the function switching switch has been operated and moves to the process of step S112. In a case in which the occupant has not operated the right function switching switch 38R in step S110, the determination becomes NO in step S110 and the CPU 20 ends the input control process.

The CPU 20 switches the functions in step S112 and changes the display in step S114. For example, the CPU 20 uses the function display unit 52 to change the display from what is illustrated in FIG. 5 to what is illustrated in FIG. 6. Furthermore, the functions allocated to the operation switches are also switched. Then, the CPU 20 ends the input control process.

In a case in which the determination was YES in step S104, in step S116 the CPU 20 determines whether or not the occupant has touched a function switching switch. Specifically, in a case in which the occupant has touched the right function switching switch 38R or the left function switching switch 38L, the determination becomes YES in step S116 and the CPU 20 moves to the process of step S118. Furthermore, in a case in which the occupant has not touched either of the right function switching switch 38R and the left function switching switch 38L, the determination becomes NO in step S116 and the CPU 20 ends the input control process.

In step S118 the CPU 20 performs a predetermined display in the display region V2. For example, in a case in which the occupant has touched any of the right first operation switch 34R, the right second operation switch 36R, and the right function switching switch 38R, the CPU 20 uses the function display unit 52 to display the right first operation switch image 34RM, the right second operation switch image 36RM, and the right function switching switch image 38RM in the display region V2 (see FIG. 7).

Next, in step S120 the CPU 20 determines whether or not the function switching switch has been operated. Specifically, in a case in which the occupant has pressed the right function switching switch 38R in a state in which the right first operation switch image 34RM, the right second operation switch image 36RM, and the right function switching switch image 38RM are being displayed in the display region V2, the CPU 20 determines that the function switching switch has been operated and moves to the process of step S122. In a case in which the occupant has not operated the right function switching switch 38R in step S120, the determination becomes NO in step S120 and the CPU 20 ends the input control process.

In step S122 the CPU 20 notifies the occupant. Specifically, the CPU 20 uses the function of the notification unit 60 to display in the display region V2 characters indicating that the functions cannot be switched. For this reason, in step S122, the functions are not switched and neither is the display changed. Then, the CPU 20 ends the input control process.

As described above, in the vehicle input control device 10 pertaining to this exemplary embodiment, by operating the right function switching switch 38R and the left function switching switch 38L, the functions allocated to each of the operation switches are switched. Due thereto, plural functions can be allocated to each of the operation switches, and the number of operation switches may be reduced.

In particular, in this exemplary embodiment, in a case in which the driving mode is the driving assistance mode, the functions allocated to each of the operation switches are inhibited from being switched from the functions relating to the driver assistance settings. For example, functions relating to changing the vehicle speed and functions relating to changing the headway in ACC may be fixed.

Furthermore, the function switching restriction unit 58 restricts switching of the functions by the function switching reception unit 56 in a case in which the driving mode of the vehicle 12 is the predetermined driving mode. Due thereto, even if the occupant mistakenly operates the right function switching switch 38R or the left function switching switch 38L in the predetermined driving mode, the functions allocated to each of the operation switches may be inhibited from being switched.

Moreover, in this exemplary embodiment, the function display unit 52 displays the functions in at least one of the display region V1 and the display region V2 in the cabin, so the occupant may easily grasp the functions allocated to each of the operation switches. Furthermore, the function display unit 52 does not switch the display when switching is restricted by the function switching restriction unit 58. Due thereto, by viewing the display region V1 or the display region V2, the occupant may grasp that switching of the functions is restricted.

Moreover still, in this exemplary embodiment, the notification unit 60 notifies the occupant, so the occupant may easily grasp that switching of the functions is restricted.

The vehicle input control system S and the vehicle input control device 10 pertaining to the exemplary embodiment have been described above, but the present disclosure may of course be implemented in various aspects in a range that does not depart from the spirit thereof. For example, in the above exemplary embodiment, an example of display in the display region V2 was described, but the disclosure is not limited to this, and display may also be performed in the display region V1.

Furthermore, in the above exemplary embodiment, a case was described where the occupant operates the right first operation switch 34R, the right second operation switch 36R, and the right function switching switch 38R, but the disclosure is not limited to this. The same also holds true in a case in which the occupant operates the left first operation switch 34L, the left second operation switch 36L, and the left function switching switch 38L. It will be noted that in a case in which the occupant has touched any of the left first operation switch 34L, the left second operation switch 36L, and the left function switching switch 38L, an image with a shape in imitation of the first operation switch 34L, an image with a shape in imitation of the left second operation switch 36L, and an image with a shape in imitation of the left function switching switch 38L may be displayed in the left-side end portion of the display region V2.

Moreover, in the above exemplary embodiment, the notification unit 60 notified the occupant by displaying characters in the display region V2, but the notification unit 60 is not limited to this. For example, the notification unit 60 may also notify the occupant that switching of the functions is restricted by outputting audio from a speaker (not illustrated in the drawings) provided in the cabin.

Moreover still, the numbers and shapes of the operation switches and the function switching switches are not particularly limited and may be appropriately changed.

What is claimed is:

1. A vehicle input control device comprising a processor, the processor being configured to:
receive input from operation switches provided in a vicinity of a driver's seat of a vehicle;
receive input from function switching switches that switch functions allocated to the operation switches; and
restrict switching of the functions in a case in which a driving mode of the vehicle is a predetermined driving mode.

2. The vehicle input control device of claim 1, wherein the processor:
causes display of the functions allocated to the operation switches at a display region in a cabin of the vehicle,
changes the display in a case in which it has received input from the function switching switches, and
maintains, without changing, the display in a case in which switching is restricted.

3. The vehicle input control device of claim 1, wherein the processor notifies an occupant in a case in which switching of the functions is restricted.

4. The vehicle input control device of claim 1, wherein:
in a case in which the driving mode is a driving assistance mode that performs driving assistance, functions relating to driving assistance settings are allocated to at least some of the operation switches, and
the processor restricts switching of the functions in a case in which the driving mode is the driving assistance mode.

5. The vehicle input control device of claim 4, wherein:
the driving assistance mode includes a cruise control mode, and
functions for changing vehicle speed and changing headway during cruise control are allocated to at least some of the operation switches.

6. A vehicle input control system comprising:
the vehicle input control device of claim 1; and
the operation switches and the function switching switches provided in the vicinity of the driver's seat.

7. A vehicle input control method comprising, by a processor:
receiving input from operation switches provided in a vicinity of a driver's seat of a vehicle;
receiving input from function switching switches that switch functions of the operation switches; and
restricting switching of the functions in a case in which a driving mode of the vehicle is a predetermined driving mode.

8. A non-transitory storage medium storing a program executable by a computer to perform a process, the process comprising:
receiving input from operation switches provided in a vicinity of a driver's seat of a vehicle;
receiving input from function switching switches that switch functions of the operation switches; and
restricting switching of the functions in a case in which a driving mode of the vehicle is a predetermined driving mode.
